(19) United States
(12) Patent Application Publication
(10) Pub. No.: US 2011/0285571 A1
(43) Pub. Date: Nov. 24, 2011

(54) SENSOR AND ALIGNMENT ADJUSTING METHOD

(75) Inventors: Seong Hee JEONG, Seoul (KR); Jae Eun Lee, Hwaseong-si (KR)

(73) Assignee: MANDO CORPORATION

(21) Appl. No.: 13/110,238

(22) Filed: May 18, 2011

(30) Foreign Application Priority Data
May 18, 2010 (KR) 10-2010-0046489

(51) Int. Cl. G01S 13/04; H01Q 3/00

(52) U.S. Cl. 342/27; 342/368

(57) ABSTRACT

Disclosed is alignment adjustment technology for a sensor, and more particularly a sensor having an antenna structure of a specific form, which enables the alignment of the sensor to be simply and accurately adjusted even without a separate mechanical adjustment device or a change in the structure of a vehicle, and an alignment adjusting method provided by the sensor.

### CROSS-REFERENCE TO RELATED APPLICATION

This application claims priority from and the benefit under 35 U.S.C. §119(a) of Korean Patent Application No. 10-2010-0046489, filed on May 18, 2010, which is hereby incorporated by reference for all purposes as if fully set forth herein.

### BACKGROUND OF THE INVENTION

1. Field of the Invention

The present invention relates to alignment adjustment technology for a sensor, and more particularly to a sensor having an antenna structure of a specific form, which enables the alignment of the sensor to be simply and accurately adjusted even without a separate mechanical adjustment device or a change in the structure of a vehicle, and an alignment adjusting method provided by the sensor.

2. Description of the Prior Art

A sensor for vehicles, such as a radar sensor, is installed on at least one specific location of a vehicle, transmits a transmission signal, and receives a reception signal reflected from an object (hereinafter, referred to as a “target”) which is around the vehicle, thereby sensing the existence or absence of the target, the position thereof, the direction thereof and/or the size thereof. A result of the sensing of the target is used in various vehicle systems of the vehicle, associated with an adaptive cruise control (ACC) function and a stop and go function for following a leading vehicle, a blind spot detection (BSD) function for detecting a vehicle blind zone, a lane change assist (LCA) function for safely changing a lane, a pre-crash function and a collision avoidance function for preventing collision with a leading vehicle, etc.

In order to accurately control various vehicle systems, it is necessary for the sensor to accurately sense the target. In addition, in order to enable the sensor to accurately sense the target, the sensor must be in alignment in the vertical and horizontal directions. Therefore, a vehicle production process includes a step of adjusting the alignment of the sensor to be installed on the vehicle in the horizontal and vertical directions. While the vehicle is traveling after the vehicle is taken out of the warehouse, a situation where the alignment of the sensor in the horizontal and vertical directions becomes inaccurate may be caused by various causes, such as fender benders or bumper collisions which may occur frequently. When such a situation is caused, a transmission signal for the detection of the target may be transmitted in a direction different from that desired for accurate detection of the target, or a reception signal reflected from the target may be received in a direction different from that desired for accurate detection of the target, which makes it impossible to accurately sense the target.

### SUMMARY OF THE INVENTION

Accordingly, the present invention has been made to solve the above-mentioned problems occurring in the prior art, and an object of the present invention is to make it possible to simply and accurately adjust the alignment of a sensor, even without a separate mechanical adjustment device or a change in the structure of a vehicle.

Also, another object of the present invention is to provide an antenna structure of a sensor which enables the alignment of the sensor to be simply and accurately adjusted, even without a separate mechanical adjustment device or a change in the structure of a vehicle.

In addition, still another object of the present invention is to make it possible to easily, simply, and accurately achieve the alignment adjustment of the sensor equipped in a vehicle before the vehicle is taken out of the warehouse, and to easily, simply, and accurately compensate for mis-alignment of the sensor caused by various causes, such as fender benders or bumper collisions, after the vehicle is taken out of the warehouse, thereby reducing the cost, time, etc. required for alignment adjustment.

In order to accomplish this object, there is provided a sensor including a plurality of antennas or a plurality of antenna groups which are arranged apart from each other by a predetermined distance in at least one direction so as to have a phase difference in at least one direction.

In accordance with another aspect of the present invention, there is provided an alignment adjusting method of a sensor, the method including: collecting data between antenna channels from a plurality of antennas or a plurality of antenna groups, which are arranged apart from each other by a predetermined distance in at least one direction so as to have a phase difference in at least one direction; calculating a phase difference in the at least one direction based on the data between the antenna channels; determining if an antenna beam is directed in a desired direction; and adjusting directivity of the antenna beam with respect to the at least one direction when the antenna beam is currently directed in an undesired direction, by either assigning a weight to each antenna channel of the plurality of antennas or the plurality of antenna groups, or by selecting one antenna or one antenna group from among the plurality of antennas or the plurality of antenna groups.

As described above, according to the present invention, it is possible to simply and accurately adjust the alignment of the sensor 100, even without a separate mechanical adjustment device or a change in the structure of a corresponding vehicle.

Also, according to the present invention, it is possible to provide an antenna structure of the sensor 100 which enables the alignment of the sensor 100 to be simply and accurately adjusted, even without a separate mechanical adjustment device or a change in the structure of a corresponding vehicle.

In addition, according to the present invention, it is possible to easily, simply, and accurately achieve the alignment adjustment of the sensor 100 equipped in a vehicle before the vehicle is taken out of the warehouse, and to easily, simply, and accurately compensate for mis-alignment of the sensor 100 caused by various causes, such as fender benders or bumper collisions, after the vehicle is taken out of the warehouse, thereby reducing the cost, time, etc. required for alignment adjustment.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a case where a sensor according to an embodiment of the present invention is applied to a vehicle;

FIG. 2 is a block diagram illustrating the configuration of a sensor according to an embodiment of the present invention;

FIG. 3 is a view illustrating an antenna structure of a sensor for providing an alignment adjustment function according to an embodiment of the present invention;

FIGS. 4A and 4B are views explaining the characteristics of the antenna structure of the sensor according to an embodiment of the present invention;

FIG. 5 is a view illustrating an antenna structure of a sensor for providing an alignment adjustment function according to another embodiment of the present invention;

FIGS. 6A and 6B are views illustrating antenna beam regions when an antenna structure of a sensor for providing an alignment adjustment function according to another embodiment of the present invention is applied to a transmission antenna unit and when the antenna structure is applied to a reception antenna unit;

FIG. 7 is a flowchart illustrating an alignment adjusting method of a sensor according to an embodiment of the present invention; and

FIG. 8 is a flowchart illustrating an alignment adjusting method of the sensor according to another embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

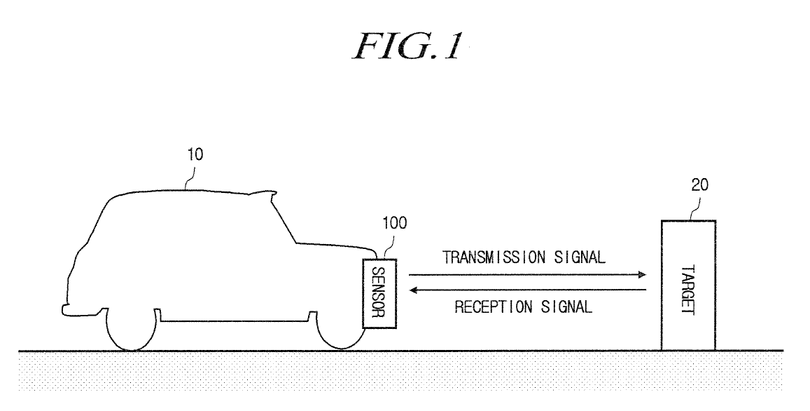

FIG. 1 is a view illustrating a case where a sensor 100 according to an embodiment of the present invention is applied to a vehicle 10.

As shown in FIG. 1, according to an embodiment of the present invention, a sensor 100 is installed on at least one specific location of a vehicle 10, transmits a transmission signal, and receives a reception signal reflected from an object (hereinafter, referred to as a “target 20”) which is around the vehicle 10, thereby sensing the existence or absence of the target 20, the position thereof, the direction thereof and/or the size thereof. A result of the sensing of the target 20 is used in various vehicle systems of the vehicle 10, associated with an adaptive cruise control (ACC) function and a stop and go function for following a leading vehicle, a blind spot detection (BSD) function for detecting a vehicle blind zone, a lane change assist (LCA) function for safely changing a lane, a pre-crash function and a collision avoidance function for preventing collision with a leading vehicle, etc.

In order to accurately control various vehicle systems, it is necessary for the sensor 100 to accurately sense the target 20. In addition, in order to enable the sensor 100 to accurately sense the target 20, the sensor 100 must be in alignment in the vertical and horizontal directions. Therefore, a vehicle production process includes a step of adjusting the alignment of the sensor 100 to be installed on the vehicle 10 in the horizontal and vertical directions. While the vehicle 10 is traveling after the vehicle is taken out of the warehouse, a situation where the alignment of the sensor 100 in the horizontal and vertical directions becomes inaccurate may be caused by various causes, such as fender benders or bumper collisions which may occur frequently. When such a situation is caused, a transmission signal for the detection of the target 20 may be transmitted in a direction different from that desired for accurate detection of the target 20, or a reception signal reflected from the target 20 may be received in a direction different from that desired for accurate detection of the target 20, which makes it impossible to accurately sense the target 20.

Therefore, in order to receive a reception signal reflected from the target 20 and to accurately sense the target 20 when a transmission signal has been transmitted to the target 20, the sensor 100 according to an embodiment of the present invention is configured to make it possible to adjust the alignment thereof in the vertical and/or horizontal direction before and after the vehicle is taken out of the warehouse.

The sensor 100 according to an embodiment of the present invention should be interpreted to include a general sensor module for transmitting/receiving a signal and sensing the target 20, and an alignment adjustment module having an alignment adjustment function.

In addition, the sensor 100 according to an embodiment of the present invention may be, for example, a radar sensor, an ultrasonic sensor, a lidar sensor, etc. However, the present invention is not limited thereto, and may be implemented even with any device capable of transmitting/receiving a signal and sensing the target 20. The sensor 100 can include a signal transmission/reception module, a target sensing module, and an alignment adjustment module, which may be implemented in one device or as separate devices.

The sensor 100 according to an embodiment of the present invention will be described in more detail with reference to the accompanying drawings.

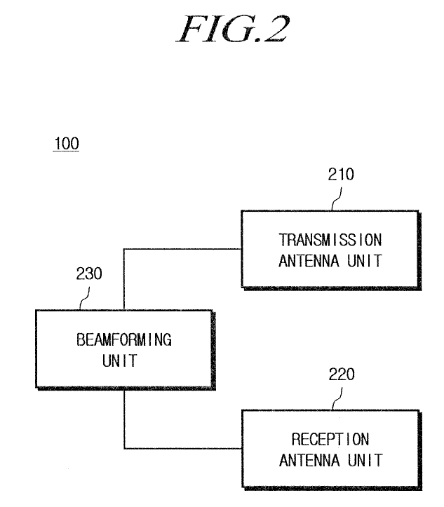

FIG. 2 is a block diagram illustrating the configuration of the sensor 100 according to an embodiment of the present invention.

Referring to FIG. 2, the sensor 100 according to an embodiment of the present invention includes a transmission antenna unit 210 including one or more transmission antennas for transmitting a transmission signal in order to sense the target 20, a reception antenna unit 220 including one or more reception antennas for receiving a reception signal generated when the transmission signal is reflected by the target 20 which is around the reception antenna unit 220, and a beamforming unit 230 for either performing a beamforming of the transmission signal with the transmission antennas or performing a beamforming of the reception signal with the reception antennas based on the sensing accuracy of the target 20, and adjusting the alignment of the sensor 100.

When a position of the sensor 100 alignment-adjusted through a beamforming is in the transmission antenna unit 210, the transmission antenna unit 210 includes the plurality of transmission antennas. In this case, the plurality of transmission antennas may be arranged apart from each other by a predetermined distance in at least one direction of the vertical or horizontal directions so as to have a phase difference in at least one direction of the vertical or horizontal directions.

In this case, the beamforming unit 230 may adjust a beam direction by assigning weights to the respective antenna channels with respect to the plurality of transmission antennas having at least one of the horizontal and vertical phase differences, or may select a transmission antenna having a specific phase difference in at least one of the horizontal and vertical directions among the plurality of transmission antennas and then perform a beamforming of a transmission signal with respect to at least one of the horizontal and vertical directions.

Here, the beamforming of the transmission signal with respect to the vertical direction may be achieved in such a manner as to select one transmission antenna from among the plurality of transmission antennas, which are arranged apart from each other by a predetermined distance in the vertical direction and have phase differences in the vertical direction, and to transmit the transmission signal through the selected transmission antenna. Also, the beamforming of the transmission signal with respect to the horizontal direction may be achieved in such a manner as to select one transmission antenna from among the plurality of transmission antennas, which are arranged apart from each other by a predetermined distance in the horizontal direction and have phase differences in the horizontal direction, and to transmit the transmission signal through the selected transmission antenna.

Meanwhile, when a position of the sensor 100 alignment-adjusted through a beamforming is in the reception antenna unit 220, the reception antenna unit 220 includes the plurality of reception antennas. In this case, the plurality of reception antennas may be arranged apart from each other by a predetermined distance in at least one direction of the vertical or horizontal directions so as to have a phase difference in at least one direction of the vertical or horizontal directions.

In this case, the beamforming unit 230 may adjust a beam direction by assigning weights to the respective antenna channels with respect to the plurality of reception antennas having at least one of horizontal and vertical phase differences based on at least one of horizontal and vertical phase differences between reception signals reflected from a target, or may select a reception antenna having a specific phase difference in at least one direction of horizontal and vertical directions among the plurality of reception antennas and then perform a beamforming of a reception signal with respect to at least one of horizontal and vertical directions.

Here, the beamforming of the reception signal with respect to the vertical direction may be achieved in such a manner as to select one reception antenna from among the plurality of reception antennas, which are arranged apart from each other by a predetermined distance in the vertical direction and have phase differences in the vertical direction, and to receive the reception signal through the selected reception antenna. Also, the beamforming of the reception signal with respect to the horizontal direction may be achieved in such a manner as to select one reception antenna from among the plurality of reception antennas, which are arranged apart from each other by a predetermined distance in the horizontal direction and have phase differences in the horizontal direction, and to receive the reception signal through the selected reception antenna.

As described above, the sensor 100 according to an embodiment of the present invention adjusts alignment with respect to the vertical direction and/or alignment with respect to the horizontal direction through the use of a phase difference based on an antenna arrangement structure. The aforementioned “antenna” may be a group of antennas including a plurality of sub-antennas.

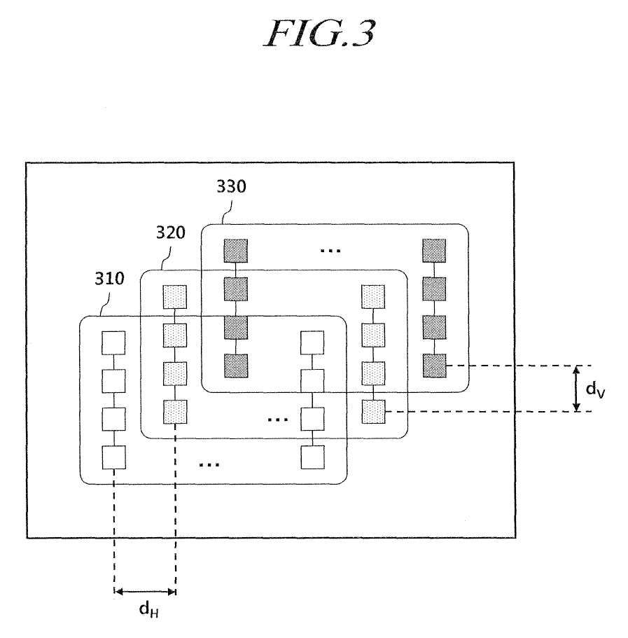

In the following description, the antenna structure of a plurality of transmission antennas included in the transmission antenna unit 210 or a plurality of reception antennas included in the reception antenna unit 220 in order to perform a beamforming will be illustratively explained with reference to FIGS. 3 to 6. Here, since performing a beamforming with respect to any one of transmission and reception signals is enough for the alignment adjustment of the sensor 100, the transmission antenna and the reception antenna will be indistinctively and inclusively designated as an “antenna” in the following description.

FIG. 3 is a view illustrating the antenna structure of the sensor 100 for providing an alignment adjustment function according to an embodiment of the present invention.

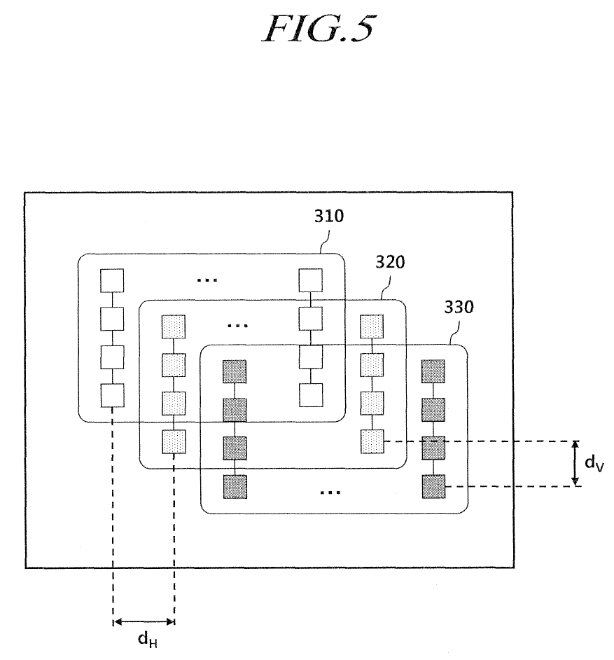

Referring to FIG. 3, the sensor 100 may include a plurality of antennas or a plurality of antenna groups 310, 320, and 330, which are arranged apart from each other by a predetermined distance in at least one direction and have a phase difference in at least one direction. The sensor 100 illustrated in FIG. 3 shows an example where the sensor 100 includes three antenna groups (i.e. a first antenna group 310, a second antenna group 320, and a third antenna group 330), which are arranged apart from each other by horizontal distance d_{H} in the horizontal direction and by vertical distance d_{V} in the vertical direction. Instead of the antenna structure of the sensor 100 illustrated in FIG. 3, the sensor 100 may be designed as illustrated in FIG. 5.

The plurality of antennas or the plurality of antenna groups 310, 320, and 330 have vertical phase difference φ_{d}_{_{V}} in the vertical direction, which is generated by the arrangement thereof spaced apart from each other by vertical distance d_{V} in the vertical direction, and/or horizontal phase difference φ_{d}_{_{H}} in the horizontal direction, which is generated by the arrangement thereof spaced apart from each other by horizontal distance d_{H} in the horizontal direction.

The vertical phase difference φ_{d}_{_{V}} in the vertical direction, which is generated because the plurality of antennas or the plurality of antenna groups 310, 320, and 330 are arranged apart from each other by the predetermined vertical distance d_{V} in the vertical direction, can be calculated based on the horizontal phase difference φ_{d}_{_{H}} and a phase difference (i.e. a difference between φ_{L} and φ_{U}) between antenna channels in the plurality of antennas or the plurality of antenna groups 310, 320, and 330.

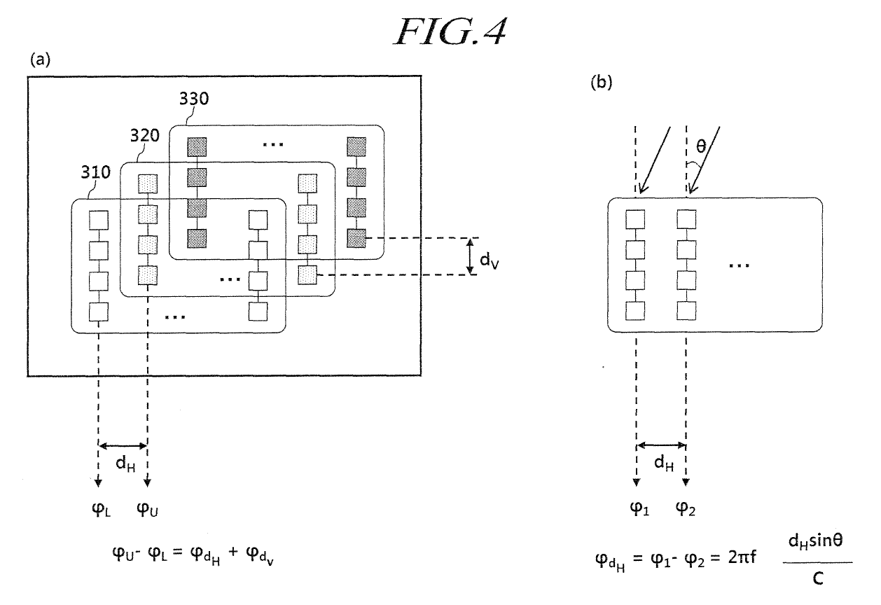

The characteristics of such an antenna structure will now be described with reference to FIGS. 4A and 4B.

Referring to FIG. 4B, in each of the plurality of antennas or each of the plurality of antenna groups 310, 320, and 330, when antennas or sub-antennas are arranged in the horizontal direction, horizontal phase difference φ_{d}_{_{H}}, i.e. φ₁-φ₂, of a signal in the horizontal direction by distance d_{H} between the respective antenna channels is generated as expressed in Equation 1 below.

$${ϕ}_{{d}_{H}} = {ϕ}_{1} - {ϕ}_{2} = 2 π f \frac{{d}_{H} sin θ}{C} \qquad ( 1 )$$

Here, referring to FIG. 4A, when the plurality of antennas or the plurality of antenna groups 310, 320, and 330 are arranged apart from each other by vertical distance d_{V} in the vertical direction, both horizontal phase difference φ_{d}_{_{H}} by horizontal distance d_{H} in the horizontal direction and vertical phase difference φ_{d}_{_{V}} by vertical distance d_{V} in the vertical direction exists in each antenna channel. Here, the horizontal phase difference φ_{d}_{_{H}} by the horizontal distance d_{H} may have a predetermined value. In this case, the vertical phase difference φ_{d}_{_{V}} in the vertical direction can be obtained using Equation 2 below by calculating phase difference φ_{U}-φ_{L} between antenna channels. φ_{U} and φ_{L}, which are phases of each antenna channel, can be obtained through Fast Fourier Transform (FFT).

φ_{U}−φ_{L}=φ_{d}_{_{H}}+φ_{d}_{_{V}} (2)

Meanwhile, the sensor 100, i.e. the beamforming unit 230, can adjust beam directions by assigning weights to the respective antenna channels with respect to a plurality of antennas or a plurality of antenna groups 310, 320, and 330, which have at least one phase difference of vertical phase difference φ_{d}_{_{V}} and horizontal phase difference φ_{d}_{_{H}}, based on at least one of vertical and horizontal phase differences between reception signals reflected from a target. Otherwise, the beamforming unit 230 can adjust beam directions of transmission or reception signals with respect to at least one of vertical and horizontal directions by selecting one of the plurality of antennas or the plurality of antenna groups 310, 320, and 330, which have vertical phase difference φ_{d}_{_{V}} in the vertical direction and/or horizontal phase difference φ_{d}_{_{H}} in the horizontal direction. Accordingly, it is possible to adjust alignment of the sensor 100 with respect to the vertical direction and/or the horizontal direction through the use of a beamforming of a transmission signal or a beamforming of a reception signal.

Meanwhile, the sensor 100, i.e. the beamforming unit 230, can sense a target 20 around the sensor 100 in real time through a beamforming with respect to at least one direction of the vertical and horizontal directions.

Meanwhile, the sensor 100, i.e. the beamforming unit 230, can adjust the beam direction of a transmission signal or the beam direction of a reception signal with respect to at least one direction of the vertical and horizontal directions based on vertical phase difference φ_{d}_{_{V}} in the vertical direction and/or horizontal phase difference φ_{d}_{_{H}} in the horizontal direction, thereby making it possible to compensate for mis-alignment in the vertical direction and/or horizontal direction, which has been caused by a vehicle tolerance generation in a vehicle production line.

Meanwhile, when it is recognized that a vehicle equipped with the sensor 30 travels on a slope having a wave in the vertical direction, the sensor 30 assigns weights to the respective antenna channels of the plurality of antennas or the plurality of antenna groups 310, 320, and 330 having the vertical phase difference φ_{d}_{_{V}}, or selects at least one of the plurality of antennas or the plurality of antenna groups 310, 320, and 330 having the vertical phase difference φ_{d}_{_{V}}, based on information on the wave of the slope, and adjusts the beam direction of the transmission or reception signal with respect to the vertical direction, thereby enabling the adjustment of the mis-alignment with respect to the vertical direction.

Also, when it is recognized that a vehicle equipped with the sensor 30 travels on a curve having a curvature in the horizontal direction, the sensor 30 assigns weights to the respective antenna channels of the plurality of antennas or the plurality of antenna groups 310, 320, and 330 having the horizontal phase difference φ_{d}_{_{H}}, or selects at least one of the plurality of antennas or the plurality of antenna groups 310, 320, and 330 having the horizontal phase difference φ_{d}_{_{H}} based on information on the curvature of the curve, and adjusts the beam direction of the transmission or reception signal with respect to the horizontal direction, thereby enabling the adjustment of the mis-alignment with respect to the horizontal direction.

Meanwhile, the sensor 30 can assign weights to the respective antenna channels of the plurality of antennas or the plurality of antenna groups 310, 320, and 330, or can select at least one of the plurality of antennas or the plurality of antenna groups 310, 320, and 330 based on the height of a target 20 around the sensor 30, and then can adjust the beam direction of the transmission or reception signal with respect to the vertical direction, thereby enabling identification of a target 20. Through this, while a vehicle is traveling, a beam can be adjusted in the vertical direction depending on the target 20, which may be a truck having a high body or a car having a low body, so that it is possible to extract accurate information on each target 20 depending on various vehicle body heights of targets.

As described above, the sensor 30, which includes a plurality of antennas or a plurality of antenna groups 310, 320, and 330 arranged apart from each other by a predetermined distance d_{V} and/or d_{H} in at least one direction, selects at least one of the plurality of antennas or the plurality of antenna groups 310, 320, and 330 having a phase difference φ_{d}_{_{V}} and/or φ_{d}_{_{H}} in at least one direction, and adjusts alignment with respect to the vertical or horizontal direction through the use of the selected antenna or antenna group, wherein the plurality of used antennas or the plurality of used antenna groups 310, 320, and 330 may be antennas or antenna groups included in the transmission antenna unit 210 or may be antennas or antenna groups included in the reception antenna unit 220. That is, alignment with respect to at least one of the vertical and horizontal directions can be adjusted by either adjusting the beam angle of a transmission signal with respect to at least one of the vertical and horizontal directions, or by adjusting the reception angle of a reception signal with respect to at least one of the vertical and horizontal directions.

When a plurality of antennas or a plurality of antenna groups 310, 320, and 330, which are arranged apart from each other by vertical distance d_{V} in the vertical direction so as to generate vertical phase difference φ_{d}_{_{V}} and/or are arranged apart from each other by horizontal direction d_{H} in the horizontal direction so as to generate horizontal phase difference φ_{d}_{_{H}}, correspond to antennas or antenna groups included in the transmission antenna unit 210, that is, when alignment with respect to at least one of the vertical and horizontal directions is adjusted by adjustment of the beam angle of a transmission signal, a sensor 100 assigns weights to the respective antenna channels of the plurality of antennas or the plurality of antenna groups 310, 320, and 330, or selects one antenna or one antenna group from among the plurality of antennas or the plurality of antenna groups 310, 320, and 330, and then adjusts the beam direction of the transmission signal with respect to at least one of the vertical and horizontal directions.

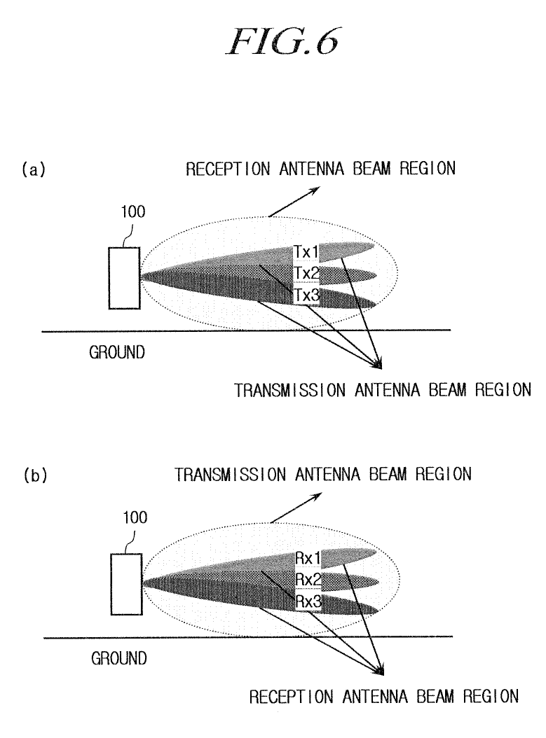

As described above, when the alignment adjustment part of the sensor 100 corresponds to the transmission antenna unit 210, a transmission antenna beam region and a reception antenna beam region of the sensor 100 may be expressed as FIG. 6A.

Referring to FIG. 6A, the respective antennas or the respective antenna groups 310, 320, and 330 included in the transmission antenna unit 210 have mutually different transmission antenna beam regions Tx1, Tx2, and Tx3 for transmitting transmission signals at different angles in at least one of the vertical and horizontal directions. In addition, the reception antennas for receiving a reception signal generated when a transmission signal is reflected from a target around the sensor have a single reception antenna beam region including all the different transmission antenna beam regions Tx1, Tx2, and Tx3.

Meanwhile, when a plurality of antennas or a plurality of antenna groups 310, 320, and 330, which are arranged apart from each other by vertical distance d_{V} in the vertical direction so as to generate vertical phase difference φ_{d}_{_{V}} and/or are arranged apart from each other by horizontal direction d_{H} in the horizontal direction so as to generate horizontal phase difference φ_{d}_{_{H}}, correspond to antennas or antenna groups included in the reception antenna unit 220, that is, when alignment with respect to at least one of the vertical and horizontal directions is adjusted by adjustment of the reception angle of a reception signal, a sensor 100 assigns weights to the respective antenna channels of the plurality of antennas or the plurality of antenna groups 310, 320, and 330, or selects one antenna or one antenna group from among the plurality of antennas or the plurality of antenna groups 310, 320, and 330, and can adjust the beam direction of the reception signal with respect to at least one of the vertical and horizontal directions.

As described above, when the alignment adjustment part of the sensor 100 corresponds to the reception antenna unit 220, a transmission antenna beam region and a reception antenna beam region of the sensor 100 may be expressed as FIG. 6B.

Referring to FIG. 6B, one antenna or one antenna group selected from among a plurality of antennas or a plurality of antenna groups 310, 320, and 330 receives a reception signal generated when a transmission signal transmitted through a transmission antenna is reflected from a target 20 around the sensor 100. In this case, the respective antennas or the respective antenna groups 310, 320, and 330 included in the reception antenna unit 220 have mutually different reception antenna beam regions Rx1, Rx2, and Rx3 for receiving reception signals reflected at different angles in at least one of the vertical and horizontal directions. In addition, the transmission antennas for transmitting a transmission signal have a single transmission antenna beam region including all the different reception antenna beam regions Rx1, Rx2, and Rx3.

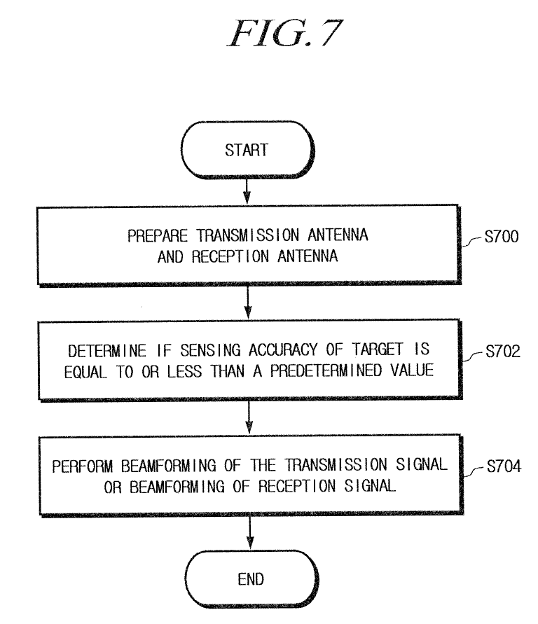

FIG. 7 is a flowchart illustrating an alignment adjusting method of a sensor 100 according to an embodiment of the present invention.

Referring to FIG. 7, the alignment adjusting method of a sensor 100 according to an embodiment of the present invention includes: step 700 of preparing one or more transmission antennas to transmit a transmission signal and one or more reception antennas to receive a reception signal generated when the transmission signal is reflected from a peripheral target; step 702 of determining if a sensing accuracy of the target is equal to or less than a predetermined value, thereby determining if alignment of a sensor 100 is required; and step 704 of performing a beamforming of the transmission signal using the transmission antennas or performing a beamforming of the reception signal using the reception antennas when it is determined that the sensing accuracy of the target is equal to or less than the predetermined value.

A method of adjusting alignment of the sensor 100 in the vertical direction will now be described in more detail.

When a transmission antenna structure is used to adjust the alignment of the sensor 100 in the vertical direction, a plurality of transmission antennas 310, 320, and 330 to transmit a transmission signal must be prepared in step 700. When it is determined that alignment of the sensor 100 is required because the sensing accuracy of the target is equal to or less than the predetermined value in step 702, a transmission antenna having a phase, the is sensing accuracy of which exceeds the predetermined value, is selected from the plurality of transmission antennas 310, 320, and 330 which are arranged apart from each other by predetermined distance d_{V} in the vertical direction and have phase difference φ_{d}_{_{V}} in the vertical direction, and a beamforming of a transmission signal with respect to the vertical direction is performed in step 704, so that the alignment of the sensor 100 in the vertical direction is adjusted.

When a reception antenna structure is used to adjust the alignment of the sensor 100 in the vertical direction, a plurality of reception antennas 310, 320, and 330 to receive a reception signal must be prepared in step 700. When it is determined that alignment of the sensor 100 is required because the sensing accuracy of the target is equal to or less than the predetermined value in step 702, a reception antenna having a phase, the sensing accuracy of which exceeds the predetermined value, is selected from the plurality of reception antennas 310, 320, and 330 which are arranged apart from each other by predetermined distance d_{V} in the vertical direction and have phase difference φ_{d}_{_{V}} in the vertical direction, and a beamforming of a reception signal with respect to the vertical direction is performed in step 704, so that the alignment of the sensor 100 in the vertical direction is adjusted.

A method of adjusting alignment of the sensor 100 in the horizontal direction will now be described in more detail.

When a transmission antenna structure is used to adjust the alignment of the sensor 100 in the horizontal direction, a plurality of transmission antennas 310, 320, and 330 to transmit a transmission signal must be prepared in step 700. When it is determined that alignment of the sensor 100 is required because the sensing accuracy of the target is equal to or less than the predetermined value in step 702, a transmission antenna having a phase, the sensing accuracy of which exceeds the predetermined value, is selected from the plurality of transmission antennas 310, 320, and 330 which are arranged apart from each other by predetermined distance d_{H} in the horizontal direction and have phase difference φ_{d}_{_{H}} in the horizontal direction, and a beamforming of a transmission signal with respect to the horizontal direction is performed in step 704, so that the alignment of the sensor 100 in the horizontal direction is adjusted.

When a reception antenna structure is used to adjust the alignment of the sensor 100 in the horizontal direction, a plurality of reception antennas 310, 320, and 330 to receive a reception signal must be prepared in step 700. When it is determined that alignment of the sensor 100 is required because the sensing accuracy of the target is equal to or less than the predetermined value in step 702, a reception antenna having a phase, the sensing accuracy of which exceeds the predetermined value, is selected from the plurality of reception antennas 310, 320, and 330 which are arranged apart from each other by predetermined distance d_{H} in the horizontal direction and have phase difference φ_{d}_{_{H}} in the horizontal direction, and a beamforming of a reception signal with respect to the horizontal direction is performed in step 704, so that the alignment of the sensor 100 in the horizontal direction is adjusted.

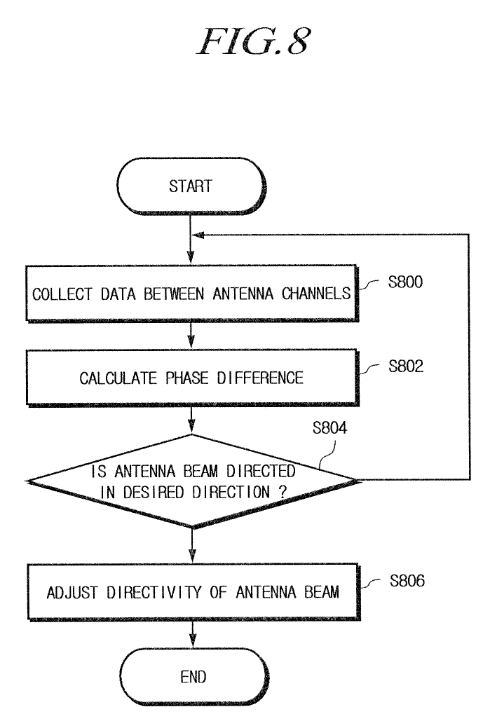

FIG. 8 is a flowchart illustrating an alignment adjusting method of the sensor 100 according to another embodiment of the present invention.

Referring to FIG. 8, the alignment adjusting method of the sensor 100 according to another embodiment of the present invention includes: step 800 of collecting data between antenna channels from a plurality of antennas or a plurality of antenna groups 310, 320, and 330, which are arranged apart from each other by predetermined distance d_{V} and/or d_{H} in at least one direction so as to have phase difference φ_{d}_{_{V}} and/or φ_{d}_{_{H}} in at least one direction; step 802 of calculating phase difference φ_{d}_{_{V}} and/or φ_{d}_{_{H}} in at least one direction based on the data between the antenna channels; step 804 of determining if an antenna beam is directed in a desired direction; and step 806 of adjusting the directivity of the antenna beam with respect to at least one direction by either assigning weights to the respective antenna channels of the plurality of antennas or the plurality of antenna groups 310, 320, and 330, or by selecting one antenna or one antenna group from among the plurality of antennas or the plurality of antenna groups 310, 320, and 330, when the antenna beam is not directed in the desired direction.

As described above, according to the present invention, it is possible to simply and accurately adjust the alignment of the sensor 100, even without a separate mechanical adjustment device or a change in the structure of a corresponding vehicle.

Also, according to the present invention, it is possible to provide an antenna structure of the sensor 100 which enables the alignment of the sensor 100 to be simply and accurately adjusted, even without a separate mechanical adjustment device or a change in the structure of a corresponding vehicle.

In addition, according to the present invention, it is possible to easily, simply, and accurately achieve the alignment adjustment of the sensor 100 equipped in a vehicle before the vehicle is taken out of the warehouse, and to easily, simply, and accurately compensate for mis-alignment of the sensor 100 caused by various causes, such as fender benders or bumper collisions, after the vehicle is taken out of the warehouse, thereby reducing the cost, time, etc. required for alignment adjustment.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A sensor comprising a plurality of antennas or a plurality of antenna groups which are arranged apart from each other by a predetermined distance in at least one direction so as to have a phase difference in at least one direction.

2. The sensor as claimed in claim 1, wherein the plurality of antennas or the plurality of antenna groups have at least one of a vertical phase difference and a horizontal phase difference, the vertical phase difference being generated when the antennas or the antenna groups are arranged apart from each other by a predetermined vertical distance in the vertical direction, the horizontal phase difference being generated when the antennas or the antenna groups are arranged apart from each other by a predetermined horizontal distance in the horizontal direction.

3. The sensor as claimed in claim 2, wherein the vertical phase difference is calculated based on the horizontal phase difference and a phase difference between antennal channels in the plurality of antennas or the plurality of antenna groups.

4. The sensor as claimed in claim 2, wherein the sensor adjusts a beam direction by assigning a weight to each antenna channel with respect to the plurality of antennas or the plurality of antenna groups, which have at least one of the vertical phase difference and the horizontal phase difference, or selects one of the plurality of antennas or the plurality of antenna groups, which have at least one of the vertical phase difference and the horizontal phase difference, thereby adjusting a beam direction of a transmission or reception signal with respect to at least one of vertical and horizontal directions.

5. The sensor as claimed in claim 4, wherein the sensor senses a peripheral target in real time through a beamforming with respect to at least one direction of the vertical and horizontal directions.

6. The sensor as claimed in claim 4, wherein the sensor adjusts a beam direction of the transmission signal or a beam direction of the reception signal with respect to at least one direction of the vertical and horizontal directions based on at least one of the vertical phase difference and the horizontal phase difference, thereby compensating for mis-alignment in at least one of the vertical and horizontal directions, which is caused by a vehicle tolerance generation in a vehicle production line.

7. The sensor as claimed in claim 4, wherein, when a vehicle equipped with the sensor recognizes a target on a slope having a wave in a vertical direction, the sensor assigns a weight to each antenna channel of the plurality of antennas or the plurality of antenna groups having the vertical phase difference, or selects at least one of the plurality of antennas or the plurality of antenna groups having the vertical phase difference, based on information on the wave of the slope, and adjusts a beam direction of the transmission or reception signal with respect to the vertical direction, thereby adjusting mis-alignment with respect to the vertical direction; and
when a vehicle equipped with the sensor recognizes a target on a curve having a curvature in a horizontal direction, the sensor assigns a weight to each antenna channel of the plurality of antennas or the plurality of antenna groups having the horizontal phase difference, or selects at least one of the plurality of antennas or the plurality of antenna groups having the horizontal phase difference, based on information on the curve of the curvature, and adjusts a beam direction of the transmission or reception signal with respect to the horizontal direction, thereby adjusting mis-alignment with respect to the horizontal direction.

8. The sensor as claimed in claim 4, wherein the sensor assigns a weight to each antenna channel of the plurality of antennas or the plurality of antenna groups, or can select at least one of the plurality of antennas or the plurality of antenna groups based on a height of a peripheral target, and adjusts a beam direction of the transmission or reception signal with respect to the vertical direction, thereby identifying the target.

9. The sensor as claimed in claim 2, wherein, when the plurality of antennas or the plurality of antenna groups having at least one of the vertical and horizontal phase differences is included in a transmission antenna unit, the sensor assigns a weight to each antenna channel of the plurality of antennas or the plurality of antenna groups, or selects one antenna or one antenna group from among the plurality of antennas or the plurality of antenna groups, and adjusts a beam direction of a transmission signal with respect to at least one of the vertical and horizontal directions.

10. The sensor as claimed in claim 9, wherein the sensor further comprises a reception antenna for receiving a reception signal obtained when the transmission signal is reflected from a peripheral target,
wherein the plurality of antennas or the plurality of antenna groups have different transmission antenna beam regions to transmit the transmission signal at different angles with respect to at least one of the vertical and horizontal directions, and the reception antenna has a single reception antenna beam region including all the different transmission antenna beam regions.

11. The sensor as claimed in claim 2, wherein, when the plurality of antennas or the plurality of antenna groups having at least one of the vertical and horizontal phase differences is included in a reception antenna unit, the sensor assigns a weight to each antenna channel of the plurality of antennas or the plurality of antenna groups, or selects one antenna or one antenna group from among the plurality of antennas or the plurality of antenna groups, and adjusts a beam direction of a reception signal with respect to at least one of the vertical and horizontal directions.

12. The sensor as claimed in claim 11, wherein the sensor further comprises a transmission antenna for transmitting a transmission signal, and one antenna or one antenna group selected from the plurality of antennas or the plurality of antenna groups receives the reception signal obtained when the transmission signal is reflected from a peripheral target,
wherein the plurality of antennas or the plurality of antenna groups have different reception antenna beam regions to receive the reception signal at different angles with respect to at least one of the vertical and horizontal directions, and the transmission antenna has a single transmission antenna beam region including all the different reception antenna beam regions.

13. An alignment adjusting method of a sensor, the alignment adjusting method comprising:
collecting data between antenna channels from a plurality of antennas or a plurality of antenna groups, which are arranged apart from each other by a predetermined distance in at least one direction so as to have a phase difference in at least one direction;
calculating a phase difference in the at least one direction based on the data between the antenna channels;
determining if an antenna beam is directed in a desired direction; and
adjusting directivity of the antenna beam with respect to the at least one direction when the antenna beam is currently directed in an undesired direction, by either assigning a weight to each antenna channel of the plurality of antennas or the plurality of antenna groups, or by selecting one antenna or one antenna group from among the plurality of antennas or the plurality of antenna groups.
